(19) United States
(12) Patent Application Publication
(10) Pub. No.: US 2025/0224769 A1
(43) Pub. Date: Jul. 10, 2025

(54) TABLET DEVICE

(71) Applicant: Getac Technology Corporation, New Taipei City (TW)

(72) Inventors: PO-YEN CHEN, Taipei City (TW); YIN-CHENG TSAI, Taipei City (TW)

(21) Appl. No.: 18/830,927

(22) Filed: Sep. 11, 2024

(30) Foreign Application Priority Data
Jan. 4, 2024 (CN) 202410012881.2

(51) Int. Cl. G06F 1/16

(52) U.S. Cl. CPC G06F 1/1637; G06F 1/1698

(57) ABSTRACT

A tablet device includes: a case having a top surface and a bottom surface, where a side button frame is provided on one side edge of the top surface; a metal support plate arranged in the case, where a hollow part is provided on one side edge of the metal support plate that corresponds to the side button frame, such that the hollow part forms a space in the case; a support frame arranged in the space; a side button sensor arranged in the side button frame; a side button control board arranged on the side edge of the metal support plate; and an antenna module arranged in the space; where the side button sensor, the support frame, and the antenna module are substantially overlapped with one another.

### CROSS-REFERENCE TO RELATED APPLICATION

This application claims the priority benefit of Chinese Patent Application 202410012881.2, filed Jan. 4, 2024. The entirety of the above-mentioned patent application is hereby incorporated by reference herein and made a part of this specification.

Some references, which may include patents, patent applications and various publications, may be cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference was individually incorporated by reference.

### FIELD OF THE INVENTION

The present invention relates to a tablet device where a button and a support frame together constitute an antenna structure.

### BACKGROUND OF THE INVENTION

Due to the limited space available in the periphery of a tablet device, it is difficult to meet the design requirements of a multi-antenna communication system while considering the needs of cost reduction/detachable antenna and the like. Therefore, how to add a new antenna in the limited space of a side button section is an important issue to be solved in the technical field.

### SUMMARY OF THE INVENTION

The present invention provides a tablet device where a new antenna is added in a limited space behind a side button, such that the side button and the antenna have a co-constructed structure.

The tablet device provided by the present invention includes: a case having a top surface and a bottom surface, where a side button frame is provided on one side edge of the top surface; a metal support plate arranged in the case, where a hollow part is provided on one side edge of the metal support plate that corresponds to the side button frame, such that the hollow part forms a space in the case; a support frame arranged in the space; a side button sensor arranged in the side button frame; a side button control board arranged on the side edge of the metal support plate; and an antenna module arranged in the space; where the side button sensor, the support frame, and the antenna module are substantially overlapped with one another.

In an embodiment of the present invention, the support frame abuts against the side button sensor.

In an embodiment of the present invention, the side button control board faces the space.

In an embodiment of the present invention, the side button control board is coupled to the side button sensor by a flexible flat cable.

In an embodiment of the present invention, the support frame is a plastic component.

In an embodiment of the present invention, the support frame is a sheet-like bracket and is configured to be clamped to the one side edge of the metal support plate that corresponds to the hollow part.

In an embodiment of the present invention, the support frame is an L-shaped bracket and is configured to be clamped to the side edge of the metal support plate and the bottom surface.

In an embodiment of the present invention, the support frame is a U-shaped bracket, and a plurality of clamping pieces are arranged on two side edges of an opening of the U-shaped bracket to be clamped to the side edge of the metal support plate.

In an embodiment of the present invention, the antenna module is a type of three-dimensional antenna.

In an embodiment of the present invention, the antenna module is a multiple-input and multiple-output antenna for a wireless wide area network.

In an embodiment of the present invention, the top surface is further provided with a display frame for fixedly arranging a display panel.

Due to the use of the support frame, the present invention discloses a tablet device where a new antenna can be added in a limited space behind a side button, such that the side button and the antenna have a co-constructed structure.

The above description is only an overview of the technical solution of the present invention, and can be implemented according to the content of the specification in order to more clearly understand the technical means of the present invention. Moreover, to make the above and other objectives, features and advantages of the present invention more obvious and understandable, a detailed description of preferred embodiments is given below with reference to the accompanying drawings.

Other objectives, features and advantages of the invention will be further understood from the further technological features disclosed by the embodiments of the invention wherein there are shown and described preferred embodiments of this invention, simply by way of illustration of modes best suited to carry out the invention.

### BRIEF DESCRIPTION OF THE DRAWINGS

FIG. 1 is a schematic diagram of a tablet device provided by a first embodiment of the present invention;

FIG. 2 is a schematic diagram of a tablet device provided by a second embodiment of the present invention;

FIG. 3 is a schematic diagram of a tablet device provided by a third embodiment of the present invention; and

FIG. 4 is a schematic diagram of an antenna module provided by an embodiment of the present invention.

### DETAILED DESCRIPTION OF PREFERRED EMBODIMENTS

To make the objective, the technical solutions and advantages of the present invention clearer, the present invention is further described in detail below in conjunction with the accompanying drawings and the embodiments. It should be understood that the specific embodiments described herein are only for explaining but not for limiting the present invention. All other embodiments obtained by those of ordinary skill in the art based on the embodiments of the present invention without creative efforts should fall within the scope of protection of the present invention.

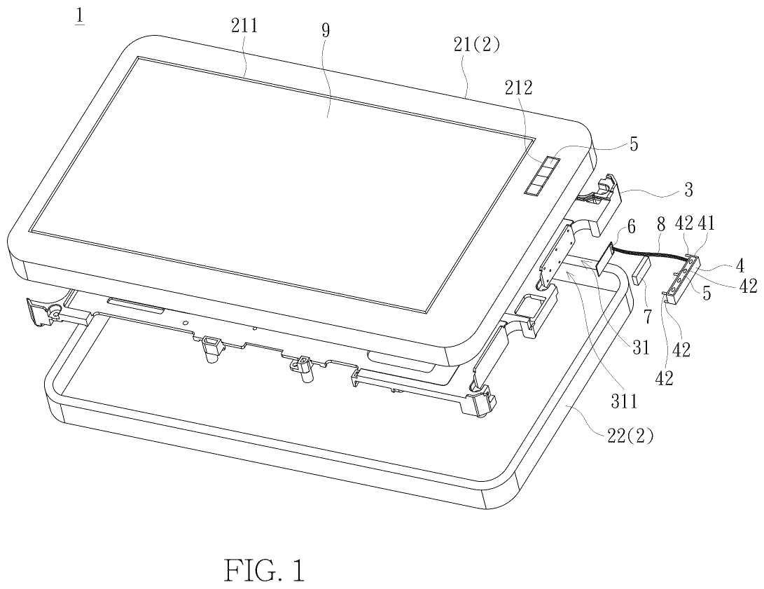

Reference is made to FIG. 1, which is a schematic diagram of a tablet device provided by a first embodiment of the present invention. The tablet device 1 provided by this embodiment includes a case 2, a metal support plate 3, a support frame 4, a side button sensor 5, a side button control board 6, and an antenna module 7. In this embodiment, the case 2 has a top surface 21 and a bottom surface 22, where the top surface 21 is provided with a display frame 212 for fixedly arranging a display panel 9, and one side edge of the top surface is provided with a side button frame 211 for fixedly arranging the side button sensor 5. It should be noted that the top surface 21 and the bottom surface 22 of the case 2 are only used to explain the upper part/top and the lower part/bottom of the case 2, and do not limit the organizational structure and combination of the case 2. For example, the case may be integrally formed or composed of an upper top case, a lower top case, and at least a side case. The metal support plate 3 is arranged in the case 2, and a hollow part 31 is provided on one side edge of the metal support plate 3 that corresponds to the side button frame 211, such that the hollow part 31 forms a space 311 in the case 2 to place the support frame 4 and the antenna module 7. The support frame 4 is arranged in the space 311 and is, for example, a U-shaped bracket, and a plurality of clamping pieces 42 are arranged on two side edges 41 of an opening of the support frame 4 to be clamped to the side edge of the metal support plate 3, where the support frame 4 is a plastic component, such that a stable space is formed in the support frame 4 to prevent space compression or distortion caused by pressing the side button sensor 5 from affecting the antenna module 7. It should be noted that the support frame 4 may also be replaced with a support component made of another material or in another form, such that a stable space is formed to place the antenna module 7. The side button sensor 5 is arranged in the side button frame 211, and a side edge 41 of the support frame 4 that corresponds to the top surface 21 abuts against the side button sensor 5, where the side button sensor 5, the support frame 4, and the antenna module 7 are substantially overlapped with one another. The side button control board 6 is arranged on the side edge of the metal support plate 3, faces the opening of the U-shaped bracket, is coupled to the side button sensor 5 by a flexible flat cable 8 to receive a signal generated by pressing the side button sensor 5, and is coupled to a system circuit board by a flat cable for signal transmission. The antenna module 7 is arranged in the space of the support frame 4, where the antenna module 7 may be a type of three-dimensional antenna or a type of planar antenna, and may be an antenna used in various wireless communication technologies such as a wireless wide area network (WWAN) and a wireless local area network (WIFI). In addition, the antenna module 7 is configured to transmit and receive the signal, and the signal can be coupled to the antenna module by a flat cable to be provided to the antenna module for signal processing.

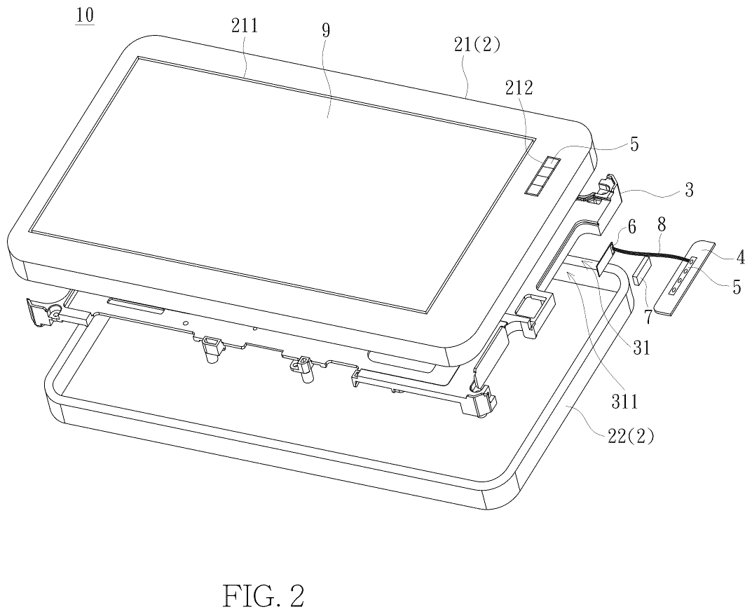

Reference is made to FIG. 2, which is a schematic diagram of a tablet device provided by a second embodiment of the present invention. It can be noted that the tablet device 10 provided by the second embodiment is roughly the same as the tablet device 1 provided by the first embodiment, and there is only the difference between the two embodiments that the support frame 4 is a sheet-like bracket and is configured to be clamped to the one side edge of the metal support plate 3 that corresponds to the hollow part 31, such that a stable space is formed below the support frame 4 to prevent space compression or distortion caused by pressing the side button sensor 5 from affecting the antenna module 7.

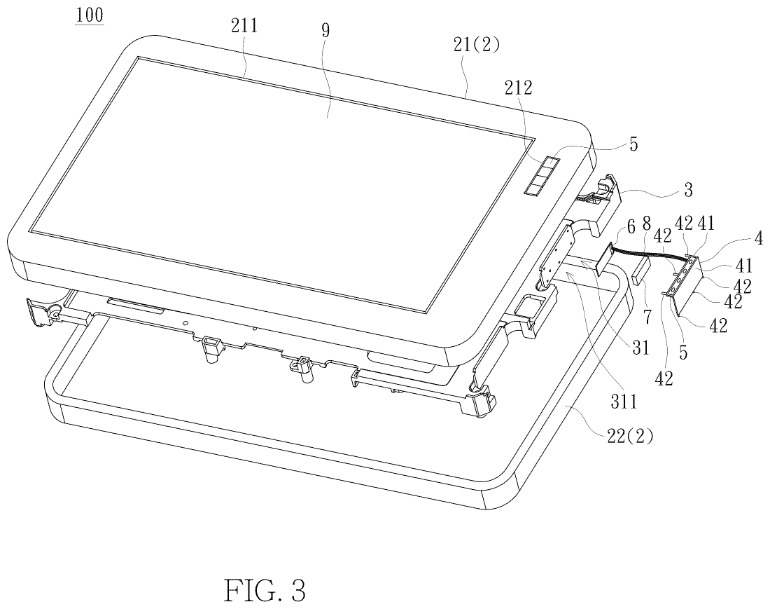

Reference is made to FIG. 3, which is a schematic diagram of a tablet device provided by a third embodiment of the present invention. It can be noted that the tablet device 100 provided by the third embodiment is roughly the same as the tablet device 1 provided by the first embodiment, and there is only the difference between the two embodiments that the support frame 4 is an L-shaped bracket, and a plurality of clamping pieces 42 are arranged on the two side edges 41 of the support frame 4 to be clamped to the side edge of the metal support plate 3 and the bottom surface 22, such that a stable space is formed below the support frame 4 to prevent space compression or distortion caused by pressing the side button sensor 5 from affecting the antenna module 7.

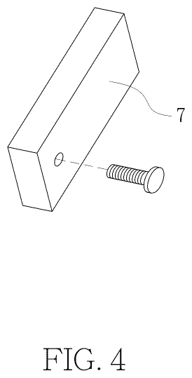

Reference is made to FIG. 4, which is a schematic diagram of an antenna module provided by an embodiment of the present invention. The antenna module 7 provided by this embodiment is fixed in the space 311 by means of locking or by other means of bonding, buckling, etc. The present invention is not limited to the means of fixing in the space 311.

In summary, due to the use of the support frame, the table device provided by the present invention is a tablet device where a new antenna can be added in a limited space behind a side button, such that the side button and the antenna have a co-constructed structure.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A tablet device, comprising:
a case having a top surface and a bottom surface, wherein a side button frame is provided on one side edge of the top surface;
a metal support plate arranged in the case, wherein a hollow part is provided on one side edge of the metal support plate that corresponds to the side button frame, such that the hollow part forms a space in the case;
a support frame arranged in the space;
a side button sensor arranged in the side button frame;
a side button control board arranged on the one side edge of the metal support plate; and
an antenna module arranged in the space;
wherein the side button sensor, the support frame, and the antenna module are substantially overlapped with one another.

2. The tablet device according to claim 1, wherein the support frame abuts against the side button sensor.

3. The tablet device according to claim 1, wherein the side button control board faces the space.

4. The tablet device according to claim 3, wherein the side button control board is coupled to the side button sensor by a flexible flat cable.

5. The tablet device according to claim 1, wherein the support frame is a plastic component.

6. The tablet device according to claim 5, wherein the support frame is a sheet-like bracket and is configured to be clamped to the one side edge of the metal support plate that corresponds to the hollow part.

7. The tablet device according to claim 5, wherein the support frame is an L-shaped bracket and is configured to be clamped to the one side edge of the metal support plate and the bottom surface.

8. The tablet device according to claim 5, wherein the support frame is a U-shaped bracket, and a plurality of clamping pieces are arranged on two side edges of an opening of the U-shaped bracket to be clamped to the one side edge of the metal support plate.

9. The tablet device according to claim 1, wherein the antenna module is a type of three-dimensional antenna.

10. The tablet device according to claim 1, wherein the antenna module is a multiple-input and multiple-output antenna for a wireless wide area network.

11. The tablet device according to claim 1, wherein the top surface is further provided with a display frame for fixedly arranging a display panel.
